(19) United States
(12) Patent Application Publication
(10) Pub. No.: US 2004/0242266 A1
(43) Pub. Date: Dec. 2, 2004

(54) Apparatus and method for communication of visual messages

(76) Inventors: Roberto Tagliabue, Boston, MA (US); Marco Susani, Boston, MA (US)

Correspondence Address: MOTOROLA INC, 600 NORTH US HIGHWAY 45, ROOM AS437, LIBERTYVILLE, IL, 60048-5343, US

(21) Appl. No.: 10/447,478

(22) Filed: May 29, 2003

(51) Int. Cl. H04Q 7/20

(52) U.S. Cl. 455/556.1; 455/466

(57) ABSTRACT

The invention is a wireless communication device (102) comprising a transceiver (206, 208), a processor (202) and an output device (220), and a method therefor. The transceiver (206, 208) communicates media messages with a plurality of communication devices. The processor (202) associates media of the media messages with spaces. Each space is a grouping of media associated with a particular group of communication entities, such as devices and/or users. The output device (220) displays a visual representation of two or more media associated with a particular space. In particular, the output device (220) displays a plurality of sub-media associated with the particular space, and each sub-media is a reduced version of original media obtained by the communication devices and/or users of the particular group.

### FIELD OF THE INVENTION

The present invention relates generally to the field of communication networks having messaging capabilities. In particular, the present invention relates to the field of messaging services for communication devices having the capability of communicating images, video, and/or multimedia.

### BACKGROUND OF THE INVENTION

Various forms of messaging are available, such as email messaging systems, instant messaging systems, short messaging systems, and multimedia messaging systems. These existing messaging systems provide an efficient conduit for communication of text information. These systems also provide the capability of attaching supplemental information, such as images and sounds, to the text information. In other words, the primary focus of each message is the text information, and secondary consideration is given to other types of information.

Unfortunately, existing messaging systems utilize the simple model of text-centric messaging, described-above, which is technical, dry and hyper efficient. Rich content, such as images, video and/or audio, is considered to be supplemental and, thus, are mere attachments to the text-centric messages. In other words, efficiency is valued more than the content of the communication.

There is a need for a messaging system that focuses on rich content, such as image, video and/or audio, instead of text. In addition, there is a need for a messaging system, and a method thereof, that conglomerates rich content of certain users and their respective devices to promote an effective form of communication.

### BRIEF DESCRIPTION OF THE DRAWINGS

FIG. 1 is a perspective view of a preferred embodiment in accordance with the present invention.

FIG. 2 is a block diagram representing an exemplary representation of one or more communication devices of FIG. 1.

FIG. 3 is a block diagram representing an exemplary representation of the server of FIG. 1.

FIG. 4 is a planar side view of an exemplary screen of one or more communication devices of FIG. 1.

FIG. 5 is a planar side view of another exemplary screen of one or more communication devices of FIG. 1.

FIG. 6 is a planar side view of yet another exemplary screen of one or more communication devices of FIG. 1.

FIG. 7 is a flow diagram representing a first preferred operation of one or more communication devices of FIG. 1.

FIGS. 8 and 9 are flow diagrams representing a preferred operation of the viewfinder procedure of FIG. 7.

FIG. 10 is a flow diagram representing a preferred operation of the editor procedure of FIG. 7.

FIG. 11 is a flow diagram representing a second preferred operation of one or more communication devices of FIG. 1.

FIG. 12 is a flow diagram representing a third preferred operation of one or more communication devices of FIG. 1.

### DETAILED DESCRIPTION OF THE PREFERRED EMBODIMENTS

The present invention is a wireless communication device comprising a transceiver, a processor and an output device. The transceiver communicates media messages with a plurality of communication devices. The processor associates media of the media messages with spaces. Each space is a grouping of media associated with a particular group of communication entities, such as communication devices and/or users. The output device displays a visual representation of two or more media associated with a particular space. In particular, the output device displays a plurality of sub-media associated with the particular space, and each sub-media is a reduced version of original media obtained by the communication devices of the particular group.

The present invention is also a wireless communication device comprising a video sensor, an audio sensor and an activation button, and a method therefor. The video sensor obtains visual data, and the audio sensor obtains audio data. The activation button activates the video sensor when it is fully depressed, and the activation button activates the audio sensor when it is partially depressed for a predetermined time period. For the method, a partial depression of the activation button of the communication device is detected, and the audio data is obtained via the audio sensor of the communication device in response to detecting the partial depression of the activation button. Then, a full depression of the activation button of the communication device is detected, and the video data is obtained via the video sensor of the communication device in response to detecting the full depression of the activation button.

The present invention is further a method for a communication device of communicating visual messages with other communication devices. For one embodiment, a first visual representation representing first visual data is provided on a display of the communication device. Next, an activation of a shutter is detected, and a second visual data is obtained in response to detecting the activation. A second visual representation representing the first and second visual data is provided on the display. For another embodiment, the second visual data is received from a remote device instead of detecting an activation of a shutter and obtaining the second visual data in response to detecting the activation.

The present invention is another method for a communication device of communicating visual messages with other communication devices. A first visual data based on a first original media is acquired, and the first visual data is associated with a particular space. As stated above, the particular space is a grouping of media associated with a particular group of communication entities, such as communication devices and/or users. Next, a first visual representation representing first visual data is provided on a display, in which the first visual representation includes a reduced version of the first original media. A second visual data based on a second original media is then acquired, and the second visual data is associated with the particular space. Thereafter, a second visual representation representing the first and second visual data is provided on the display. The second visual representation includes reduced versions of the first and second original media.

Although the embodiments disclosed herein are particularly well suited for use with a cellular telephone, persons of ordinary skill in the art will readily appreciate that the teachings of this disclosure are in no way limited to cellular telephones. On the contrary, persons of ordinary skill in the art will readily appreciate that the teachings of this disclosure can be employed with any wireless communication device such as a pager, a personal digital assistant (“PDA”), a wireless communication-capable still image camera, a wireless communication-capable video camera, and the like.

The wireless communication system in accordance with the present invention is described in terms of several preferred embodiments, and particularly, in terms of a wireless communication system operating in accordance with at least one of several standards. These standards include analog, digital or dual-mode communication system protocols such as, but not limited to, the Advanced Mobile Phone System (“AMPS”), the Narrowband Advanced Mobile Phone System (“NAMPS”), the Global System for Mobile Communications (“GSM”), the IS-55 Time Division Multiple Access (“TDMA”) digital cellular system, the IS-95 Code Division Multiple Access (“CDMA”) digital cellular system, CDMA 2000, the Personal Communications System (“PCS”), 3G, the Universal Mobile Telecommunications System (“UMTS”), and variations and evolutions of these protocols. The wireless communication system in accordance with the present invention may also operate via an ad hoc network and, thus, provide point-to-point communication with the need for intervening infrastructure. Examples of the communication protocols used by the ad hoc networks include, but are not limited to, IEEE 802.11a, IEEE 802.11b, IEEE 802.11g, Bluetooth, and infrared technologies.

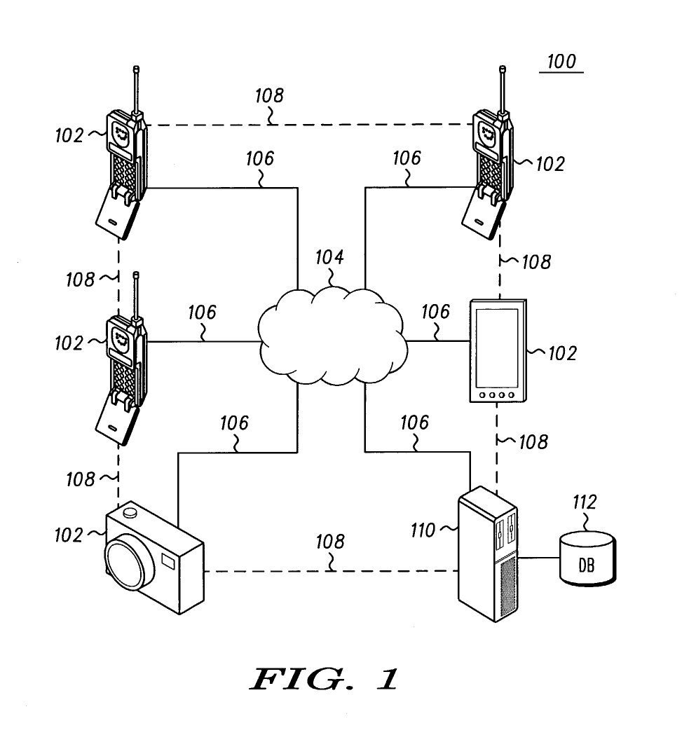

Referring to FIG. 1, there is shown a communication system 100 in accordance with the present invention. The communication system 100 includes a plurality of communication devices 102 communicating with each other. For one embodiment of the system 100, the plurality of communication devices 102 may communicate through a communications network 104 via network connections 106 as shown in FIG. 1. For another embodiment of the system 100, the plurality of communication devices 102 may communicate with each other directly via direct links 108, i.e., a point-to-point or ad hoc network.

The communication system 100 may employ any communication device having image, audio and/or video recording capabilities. Combinations of such capabilities include, but are not limited to, images plus audio and video plus audio capabilities. Examples of communication devices 102 that may have image and/or video recording capabilities include, but are not limited to, personal digital assistants (“PDA's”), cellular telephones, radiophones, handheld computers, small portable/laptop/notebook/sub-notebook computers, tablet computers, hybrid communication devices, still image cameras having wireless communication capabilities, video cameras having wireless communication capabilities, and the like.

The communication system 100 also includes a messaging application for operating a messaging system among the communication devices 102. For one embodiment, the messaging application may be operated by a server 110 and associated database 112 that communicate through the communication network 104 via the network connections 106, communicate with the communication devices 102 directly via direct links 108, or a combination thereof. For another embodiment, the messaging application may be operated by one of the communication devices 102 communicating with other communication devices, or distributed among a plurality of communication devices, that communicate through the communication networks 104 via the network connections 106, communicate directly via direct links 108, or a combination thereof.

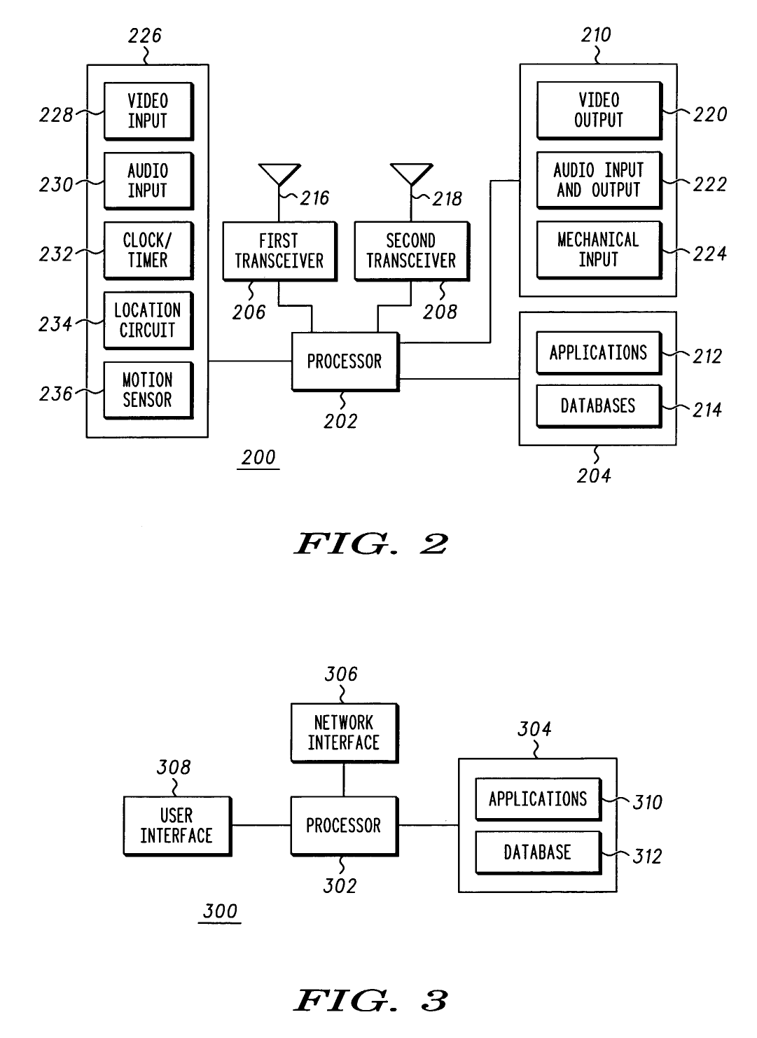

FIG. 2 shows various exemplary components that may be utilized by each communication device 102 of the communication system 100. Each communication device 102 may include a processor 202 and a memory 204, one or more transceivers 206, 208, and a user interface 210 that are coupled together for operation of the respective communication device. It is to be understood that two or more of these internal components 200 may be integrated within a single package, or functions of each internal component may be distributed among multiple packages, without adversely affecting the operation of each communication device 102.

As stated above, each communication device 102 includes the processor 202 and the memory 204. The processor 202 controls the general operation of the communication device 102 including, but not limited to, processing and generating data for each of the other internal components 200. The memory 204 may include an applications portion 212, and/or a database portion 214. The applications portion 212 includes operating instructions for the processor 202 to perform various functions of the communication device 102. A program of the set of the operating instructions may be embodied in a computer-readable medium such as, but not limited to, paper, a programmable gate array, flash memory, application specific integrated circuit (“ASIC”), erasable programmable read only memory (“EPROM”), read only memory (“ROM”), random access memory (“RAM”), magnetic media, and optical media. The database portion 214 stores data that is utilized by the applications stored in the applications portion 212. For the preferred embodiment, the applications portion 212 is non-volatile memory that includes a client application 216 for communicating with a main application operated at a remote device, and the database portion 214 is also non-volatile memory that stores data in a database that is utilized by the client application and associated with the communication device 102 or user of the communication device. In the alternative, a messaging system, or a portion thereof, may be stored in the memory 204 of a particular communication device 102.

Each communication device 102 also includes one or more transceivers 206, 208. Each transceiver 206, 208 provides communication capabilities with other entities, such as the communication network 104 and/or other communication devices 102. For the preferred embodiment, each transceiver 206, 208 operates through an antenna 216, 218 in accordance with at least one of several standards including analog, digital or dual-mode communication system protocols and, thus, communicates with appropriate infrastructure. However, as referenced above, each transceiver 206, 208 may also provided point-to-point communication via an ad hoc network.

Each communication device 102 also includes the user interface 210. The user interface 210 may include a visual interface 220, an audio interface 222 and/or a mechanical interface 224. Examples of the visual interface 220 include displays and cameras, examples of the audio interface 222 include speakers and microphones, and examples of the mechanical interface 224 includes keypads, touch pads, touch screens, selection buttons, vibrating mechanisms, and contact sensors. For example, a user may utilized the user interface 210 to provide input to be shown on a display and make selections for the display by using mechanical instructions, e.g., touching a touch pad overlapping the display, keypad keys or selection buttons, or providing audible commands and data into a microphone. For all preferred embodiments of the present invention, each communication device 102 includes a display to provide output information associated with the messaging system to corresponding users. On the other hand, alternative embodiments may include other types of output devices, audio or mechanical, to provide output to users.

Each mobile station 102 may further include a sensor 226. The sensor 210 detects one or more information or events of its corresponding mobile station 102 with or without user intervention. For the preferred embodiment, each mobile station 102 includes a video input 228 and may optionally include one or more of the following additional sensors: an audio input 230, a clock/timer 232, a location circuit 234, and a motion sensor 236. The video input 228 provides static images or dynamic video to the other components of the mobile station 102. Examples of the video input 228 include, but are not limited to, a still-image camera, a video camera, and the like. The clock/timer 232 may detect or track a current time of the mobile station 102, and detect or tracks an elapsed time in relation to a given time. The location circuit 234 detects a location of the mobile station based on internal circuitry, via an external source, or both. Examples of the location circuit 234 include, but are not limited to, a global positioning system (GPS), a beacon system, and a forward link trilateration (FLT) system. The motion sensor 236 detects orientations or movements of the mobile station 102 as it is operated by its user. Examples of the motion sensor 236 include, but are not limited to, an accelerometer, a gyroscope, and the like.

Referring to FIG. 3, the server 110 communicates with, or is part of, the communication network 104 and includes various internal components 300. It is to be understood that communication devices 102 may communicate with each other directly or through the communication network 104 without accessing the server 110 and, thus, the server is not required for proper operation in accordance with the present invention. For example, each communication device 102 may communication with a main application located at another communication device instead of an application located at the server 110. The server 110 includes a processor 302 and a memory 304, and a network interface 306 that are coupled together for operation of the server. Optionally, the server 110 may also include a user interface 308 for interactive input and output of information with a user when installing, operating and/or maintaining the server. It is to be understood that two or more of these internal components 300 may be integrated within a single package, or functions of each internal component may be distributed among multiple packages, without adversely affecting the operation of the server 110.

As stated above, the server 110 includes the processor 302 and the memory 304 and operates similarly to the processor 202 and the memory 204 of each communication device 102. The processor 302 controls the general operation of the server 110 including, but not limited to, processing and generating data for each of the other internal components 300. A program of the set of the operating instructions may be embodied in a computer-readable medium such as, but not limited to, paper, a programmable gate array, flash memory, ASIC, EPROM, ROM, RAM, magnetic media, and optical media. The memory 304 may include an applications portion 310 and a database portion 312. The applications portion 310 includes operating instructions for the processor 302 to perform various functions of the server 110. The database portion 312 stores data that is utilized by the applications stored in the applications portion 310. For example, the applications portion 310 is non-volatile memory that may include a main application for communicating with a client application operated at one or more communication devices 102, and the database portion 312 is also non-volatile memory that stores data utilized by the main application and associated with the communication devices, the users of the communication devices, and/or the server 110.

The server 110 may be operatively coupled to a database within the database portion 312 and coupled to, or integrated in, the communication network 104. The server 110 may operate as a central server from the communication network 104 to provide the main application as described herein. Alternatively, the main application may be communication device-centric and reside in an applications portion 212 of at least one of the plurality of communication devices 102. That is, one of the communication devices 102 may act as a host communication device or several communication devices may act in conjunction with each other to operate the main application as described herein. In either case, each communication device 102 that does not include the main application would have a client application that communicates with the main application. If a communication device 102 includes the main application, that particular communication device may or may not include a client application.

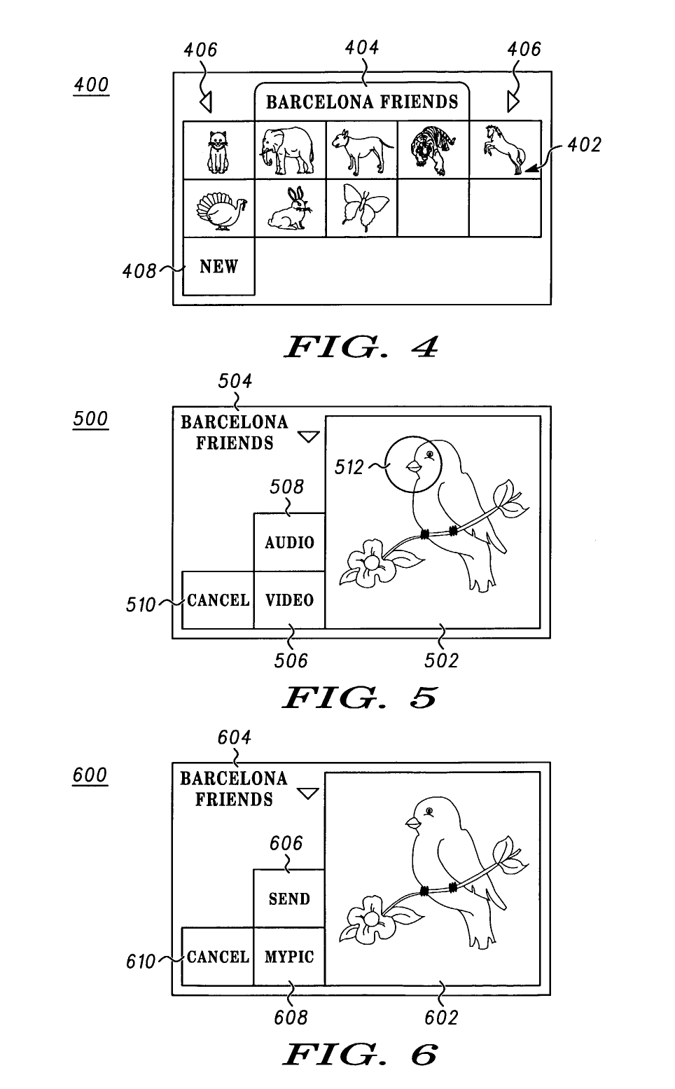

FIG. 4 represents an exemplary screen, i.e., space screen 400, of a typical space 402 that may be shown by a communication device 102 or, more particularly, the video output 220 of a device. The space 402, in accordance with the present invention, is a grouping of media, such as an image, video and/or audio (including images, audio, video, images plus audio and video plus audio), associated with a particular group of communication entities, such as communication devices 102 and/or users. The particular group must include multiple communication devices or users, i.e., two or more devices or users, but may include a potentially unlimited number of devices or users. In addition, the space 402 must include multiple media, i.e., two or more media, shown concurrently on a space screen 400. For example, for the space shown in FIG. 4, there is an opportunity to show ten (10) images within this particular space 402.

For a space screen 400, a video output 220 may also provide various other, complementary objects. In particular, the space screen 400 may include a space identification 404, space navigation icons 406 and a viewfinder icon 408. The space identification 404 indicates a specific identification name or number corresponding to the space 402 currently shown by the video output 220. For example, as shown in FIG. 4, the current space 402 shown on the space screen 400 is “Barcelona Friends” and includes certain friends associated with Barcelona by the current user. The space navigation icons 406, if selected by the user, changes the current space by assigning a different space to be the current space. For example, as shown in FIG. 4, the space navigation icons 406 are shown as navigation arrows provided at the top and bottom of the space screen 400. Selection of one arrow will result in a previous space being shown at the video output 220, and selection of the other arrow will result in a subsequent space being shown at the video output. The view finder icon 408, if selected by the user, causes the video output 220 to provide a viewfinder screen, as exemplified by FIGS. 5 and 6, instead of the space screen 400. It should be noted that selection of any object on a screen, including those shown in FIGS. 4 through 6, may be performed by a user by selection of keys or touch areas corresponding to screen objects, selection of a corresponding area of an overlaying touch screen, or navigation of a direction tool (such as a navigation disc, pointer, joystick, or similar switch) to identify the object to be selected.

FIG. 5 represents an exemplary screen, i.e., viewfinder screen 500, of a typical viewfinder 502 that may be shown by the video output 220 of a communication device 102. In particular, the viewfinder screen 500 is shown by the video output 220 before an image or video is recorded by the video input 228 and/or the audio input 230 of the communication device 102. The viewfinder 502 represents a live signal received from the video input 228. An image or video is recorded when an actuation button or area of the user interface 210 is selected by a user of the communication device 102. The viewfinder 502 of the viewfinder screen 500 shows objects as viewed by the video input 228. At any given time, the communication device 102 and/or the focal objects may be moving and, thus, the viewfinder 502 will shown corresponding movement. The viewfinder shows views as “seen” by the video input 228 and, thus, provides dynamic viewing of images and/or video.

In the alternative, in accordance with the present invention, the communication device 102 may not have viewfinder screen 500 or may not include a viewfinder 502 within a viewfinder screen 500. Instead, the communication device may include a direct viewfinder (not shown) to provide direct viewing through the video input 228. The viewfinder 502 represents a live view received via the video input 228. For example, a user may view through an optical eyepiece to see objects directly through a corresponding optical lens.

For a viewfinder screen 500, the video output 220 may also provide various other, complementary objects. In particular, the viewfinder screen 500 may include a space identification 504, image/video selection 506, an audio selection 508, a cancel selection 510, and a zoom selection 512. The space identification 504 indicates a specific identification name or number corresponding to the current space. The image/video selection 506 indicates whether the communication device 102 is prepared to record image information or video information when a shutter or actuation button is actuated by the user. For example, if the user selects the image/video selection 506 when it indicates “image”, then the image/video selection will indicate “video”; if the user selects the image/video selection when it indicates “video”, then the image/video selection will indicate “image”. The audio selection 508 indicates whether audio information will be recorded to correspond to the recorded image or video. The cancel selection 510 indicates whether the video output 220 should return to a previous screen, such as the space screen 400. The zoom selection 512 indicates the degree in which the view of the viewfinder 502 is magnified or reduced.

FIG. 6 represents an exemplary screen, i.e., progression screen 600, of a representation of a recorded image or video 602 that may be shown by the video output 220 of a communication device 102. In particular, the progression screen 600 is shown by the video output 220 after an image or video is recorded by the video input 228 and/or the audio input 230 of the communication device 102. As stated above, an image or video is recorded when an actuation button or area of the user interface 210 is selected by a user of the communication device 102. The representation 602 may be the actual image, or a scaled-version of the image, that is recorded if the communication device has recorded an image; and the representation may be the actual video, a sampled image of the video, a sampled video of the video, or a scaled-version of the video that is recorded if the communication device has recorded a video.

For a progression screen 600, the video output 220 may also provide various other, complementary objects. In particular, the viewfinder screen 600 may include a space identification 604, send selection 606, a personal area selection 608, and cancel selection 610. The space identification 604 indicates a specific identification name or number corresponding to the current space. The send selection 606 indicates whether send the recorded image and video, along with any corresponding audio, to a remote device. The personal area selection 608, if selected by the user, causes the communication device 102 to store the recorded image or video, along with any corresponding audio, a database portion 214 of the memory 204. The communication device 102 may also permit the user to manipulate information stored in the database portion 214. The cancel selection 610 indicates whether the video output 220 should return to a previous screen, such as the space screen 400.

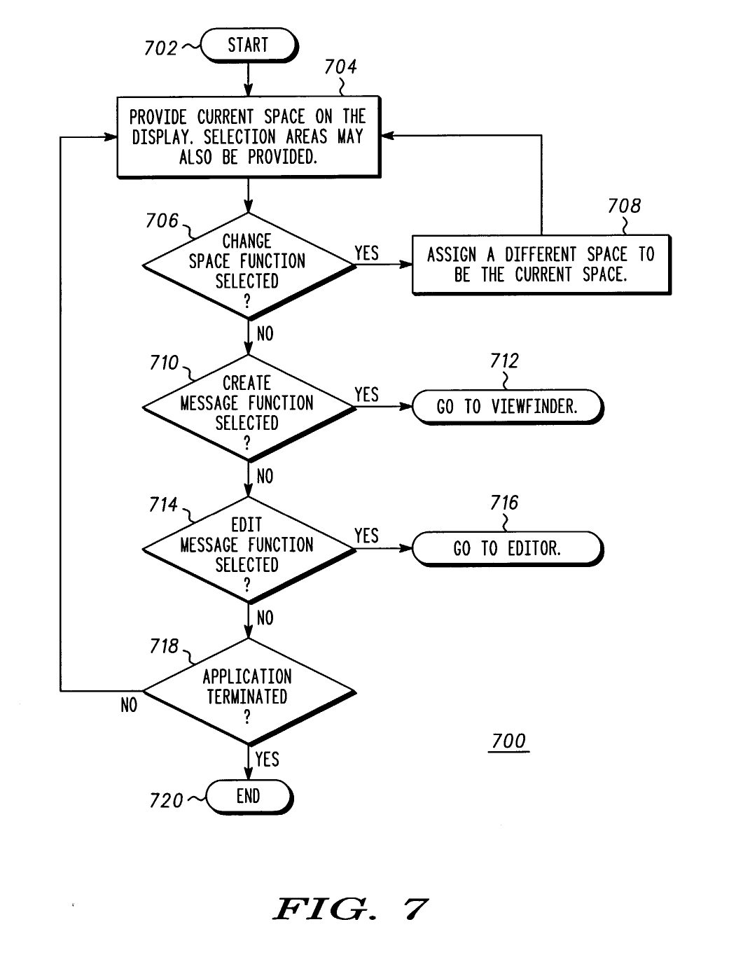

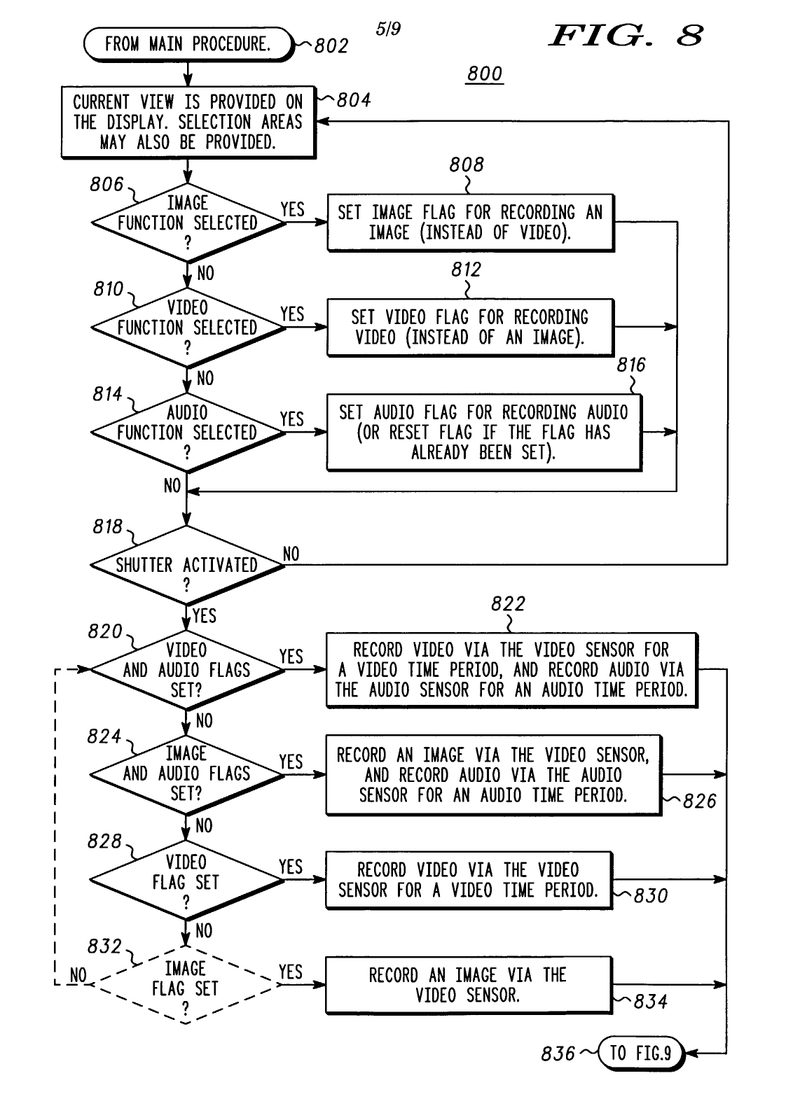

Referring to FIG. 7, there is provided a flow diagram representing a first preferred operation of a main procedure 700 of one or more communication devices 102. Beginning at step 702 of the main procedure 700, the video output 220 of the communication device 102 provides the current space as step 704. In addition, selection areas may also be provided for each of the functions described below.

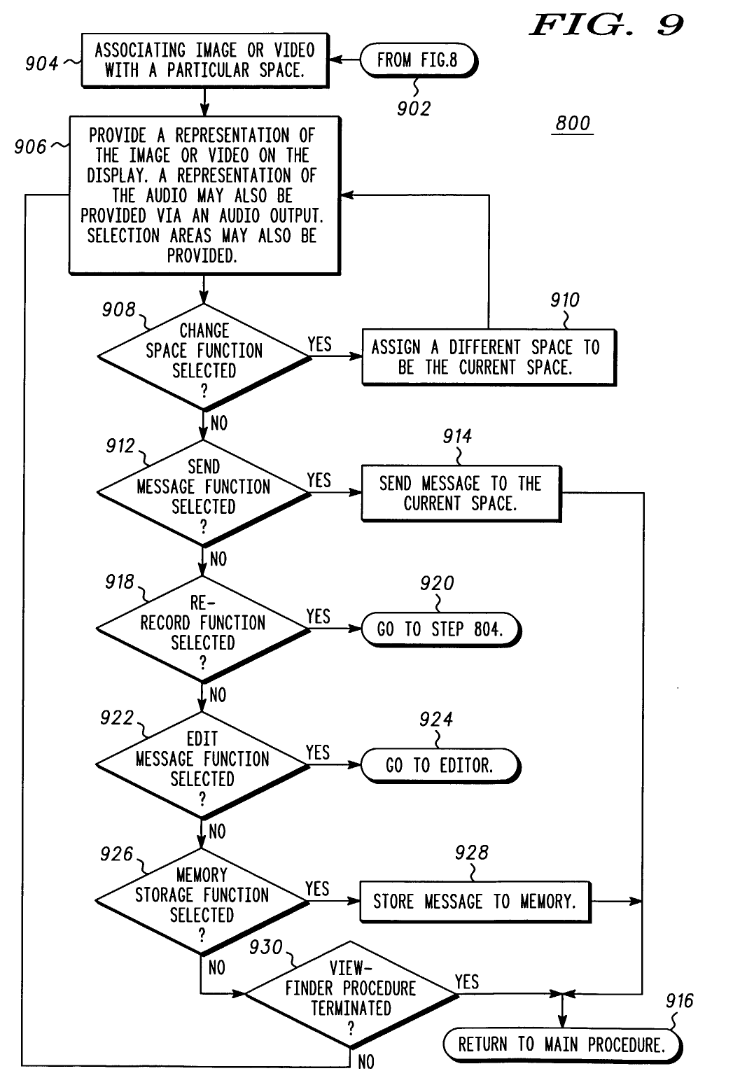

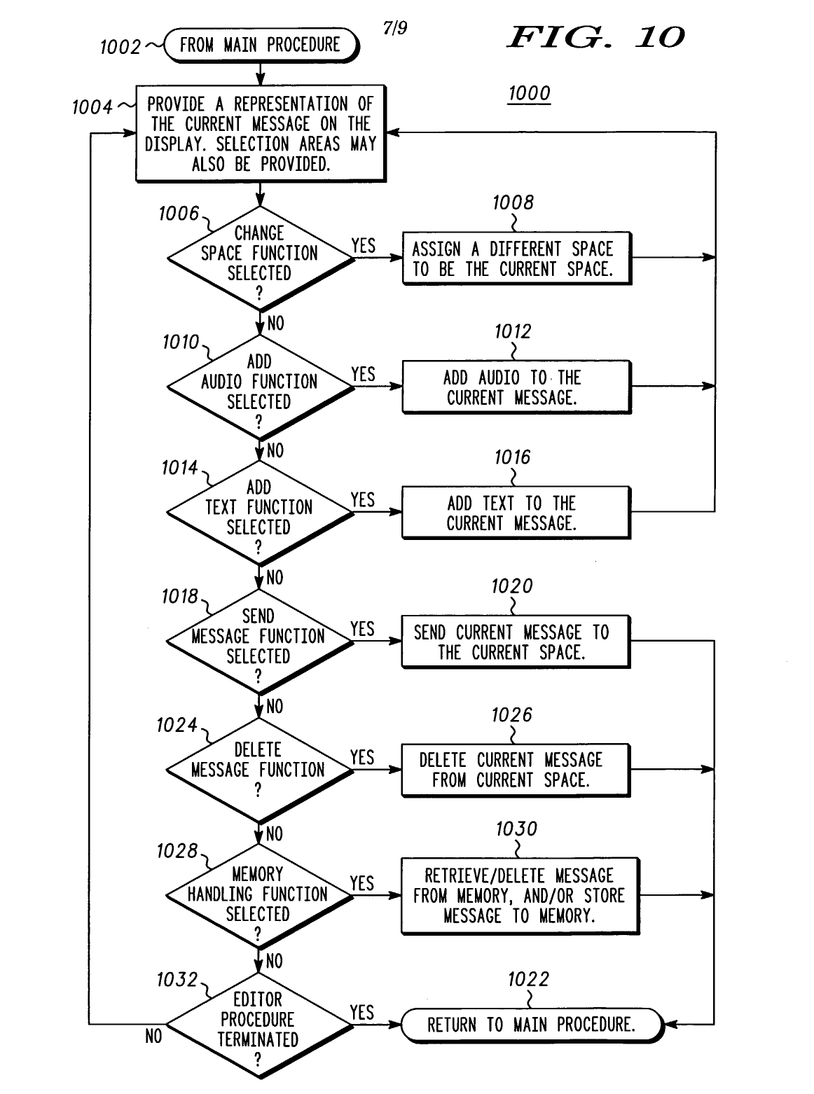

If a change space function is selected via the user interface 210 at step 706, then the processor 202 of the communication device 102 assigns a different space to be the next current space at step 708 and provide this new current space at step 704. For example, the change space function may be selected by selecting a space navigation icon 406. If the change space function is not selected via the user interface 210, then the processor 202 may determine whether a create message function is selected via the user interface at step 710. If so, then the processor 202 executes the viewfinder procedure of FIGS. 8 and 9, described below, at step 712. Otherwise, the processor 202 may determine whether an edit message function is selected via the user interface 210 at step 714. If so, then the processor 202 executes the editor procedure of FIG. 10, described below, at step 716. Otherwise, the processor 202 may determine whether the application is to be terminated via the user interface 210 at step 718. If the application is to be terminated, then the main procedure 700 terminates at step 720. If the application is not to be terminated, then the main procedure 700 continues to provide the current space on the video output 220 at step 704.

Referring to FIGS. 8 and 9, there are provided flow diagrams representing a preferred operation of the viewfinder procedure 800. Beginning at step 802 of the viewfinder procedure 800, the video output 220 of the communication device 102 provides a current view or viewfinder as step 804. As described above in reference to the viewfinder 502 of FIG. 5, the current view or viewfinder represents a live signal received from the video input 228. In addition, selection areas may also be provided for each of the functions described below.

If an image function is selected via the user interface 210 at step 806, then the processor 202 of the communication device 102 sets an image flag for recording an image at step 808. If a video function is selected via the user interface 210 at step 810, then the processor 202 of the communication device 102 sets a video flag for recording a video at step 812. If an audio function is selected via the user interface 210 at step 814, then the processor of the communication device 102 sets or resets an audio flag for recording audio at step 816. For example, if the audio flag is set for recording audio, then the selection will reset the audio flag for no recording of audio; if the audio flag is not set of recording audio, then the selection will set the audio flag for recording of audio. The processor 202 then determines whether the shutter has been activated at step 818. If the shutter has not been activated, then the processor continues to provide the current view on the video output 220 at step 804.

If the shutter has been activated at step 818, then the processor 202 of the communication device 102 records the appropriate information. If the processor 202 determines that the video and audio flags are set at step 820, then the communication device 102 records video information via the video input 228 for a video time period and records audio information via the audio input 230 for an audio time period at step 822. The video time period and the audio time period may be predetermined when the communication device 102 is manufactured, or preconfigured by a user before the shutter is activated. If the processor 202 determines that the image and audio flags are set at step 824, then the communication device 102 records image information via the video input 228 and records audio information via the audio input 230 for an audio time period at step 826. For both steps 822 and 826, the audio information may be pre-recorded before the shutter is activated, recorded when the shutter is activated, or post-recorded after the image or video is recorded. If the processor 202 determines that only the video flag is set at step 828, then the communication device 102 records video information via the video input 228 for a video time period at step 830. If the processor 202 determines that only the image flag is set at step 832, then the communication device 102 records image information via the video input 228 at step 834. In the alternative, if the determines of steps 820, 824 and 828 result in negative answers, then the processor 202 may execute step 834 by default, thereby skipping step 832. Regardless of what information if recorded, each of steps 822, 826, 830 and 834 shall continue to the remainder of the viewfinder procedure 800 at step 836.

Referring to FIG. 9, the viewfinder procedure 800 continues at step 902 and, then, associates the recorded image or video with a particular space at step 904. For the preferred embodiment, the particular space is determined before the shutter is actuated and is indicated by the space identification 404, 504, 604 of the space screen 400, viewfinder screen 500, and progression screen 600, respectively. The video output 220 then provides a representation of the current message, i.e., recorded image or video along with any corresponding audio, at step 906. If recorded audio corresponds to the recorded image or video, then optionally the recorded audio may be provided, for example, by the audio output 222. In addition, selection areas may also be provided for each of the functions described below.

If a change space function is selected via the user interface 210 at step 908, then the processor 202 of the communication device 102 assigns a different space to be the next current space at step 910 and provide this new current space at step 906. If the change space function is not selected via the user interface 210, then the processor 202 may determine whether a send message function is selected via the user interface at step 912. If so, then the processor 202 sends a message that includes the image or video, along with any corresponding audio, to one or more remote devices at step 914 and return to the main procedure 700 at step 916. As described above, the communication device 202 may send the message directly to other communication devices or through the communication network 104. Otherwise, the processor 202 may determine whether a re-record function is selected via the user interface 210 at step 918. If so, then the processor 202 at step 920 returns to the beginning of the viewfinder procedure 800, i.e., step 804. Otherwise, the processor 202 may determine whether an edit message function is selected via the user interface 210 at step 922. If so, then the processor 202 executes the editor procedure of FIG. 10, described below, at step 924. Otherwise, the processor 202 may determine whether a memory storage function is selected via the user interface 210 at step 926. If so, then the processor 202 stores the message to the memory 204, particularly the database portion 214, at step 928 and return to the main procedure 700 at step 916. Otherwise, the processor 202 may determine whether the viewfinder procedure 800 is to be terminated at step 930. If the viewfinder procedure 800 is to be terminated, then the processor 202 returns to the main procedure 700 at step 916. If the viewfinder procedure 800 is not to be terminated, then the viewfinder procedure 800 continues to provide the representation of the image or video on the video output 220 at step 906.

Referring to FIG. 10, there is provided a flow diagram representing a preferred operation of the editor procedure 1000. The video output 220 provides a representation of the current message, i.e., recorded image or video along with any corresponding audio, at step 1004. If recorded audio corresponds to the recorded image or video, then optionally the recorded audio may be provided, for example, by the audio output 222. In addition, selection areas may also be provided for each of the functions described below.

If a change space function is selected via the user interface 210 at step 1006, then the processor 202 of the communication device 102 assigns a different space to be the next current space at step 1008 and provide this new current space at step 1004. If the change space function is not selected via the user interface 210, then the processor 202 may determine whether an add audio function is selected via the user interface at step 1010. If so, then the audio input 230 of the communication device 102 records audio information or identifies pre-recorded audio information and attaches it to the current message at step 1012. The processor 202 then returns to providing the representation of the current message, as modified at step 1012, at step 1004. If the add audio function is not selected via the user interface 210, then the processor 202 may determine whether an add text function is selected via the user interface at step 1014. If so, then the user interface 210 of the communication device 102 receives user input to generate the text information or identifies pre-established text information and attaches it to the current message at step 1016. The processor 202 then returns to providing the representation of the current message, as modified at step 1016, at step 1004.

If the add text function is not selected via the user interface 210, then the processor 202 may determine whether a send message function is selected via the user interface at step 1018. If so, then the processor 202 sends a message that includes the image or video, along with any corresponding audio and/or text, to one or more remote devices at step 1020 and return to the main procedure 700 at step 1022. As described above, the communication device 202 may send the message directly to other communication devices or through the communication network 104. Otherwise, the processor 202 may determine whether a delete message function is selected via the user interface 210 at step 1024. If so, then the processor 202 no longer associates the current message with the current space at step 1026. In the alternative, the processor 202 may associate the current message with a different space. Otherwise, the processor 202 may determine whether a memory handling function is selected via the user interface 210 at step 1028. If so, then the processor 202 may perform any number of memory handling procedures at step 1030, such as retrieving stored messages, deleting the stored messages from the memory 204, and storing messages to the memory. Otherwise, the processor 202 may determine whether the editor procedure 1000 is to be terminated at step 1032. If the editor procedure 1000 is to be terminated, then the processor 202 returns to the main procedure 700 at step 1022. If the editor procedure 1000 is not to be terminated, then the editor procedure continues to provide the representation of the current message on the video output 220 at step 1004.

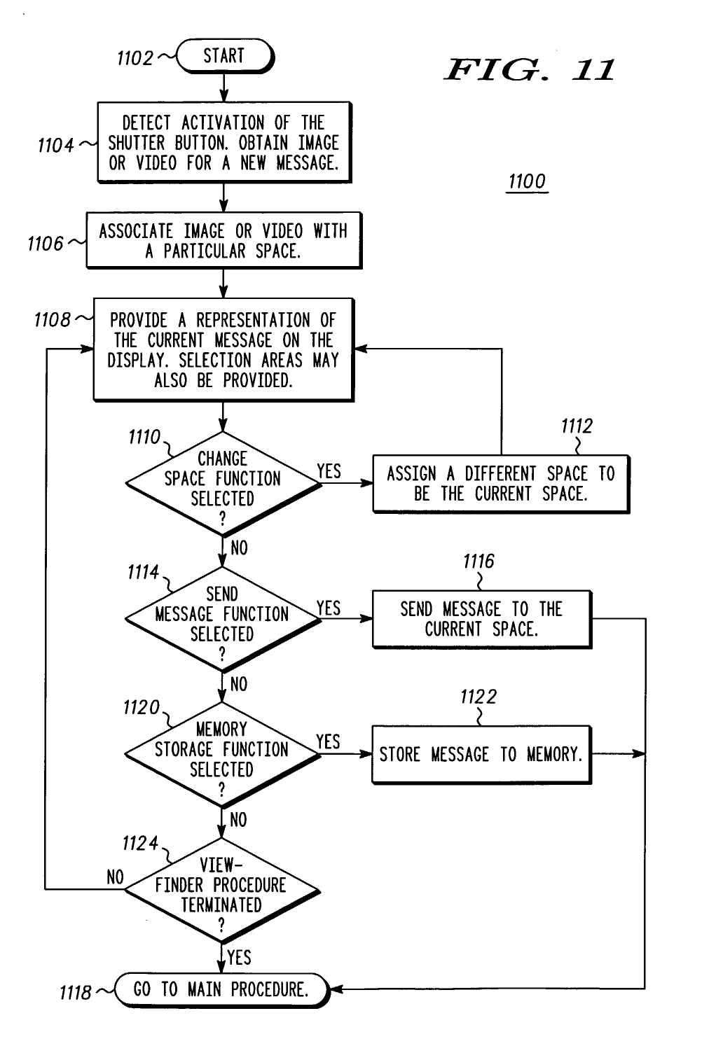

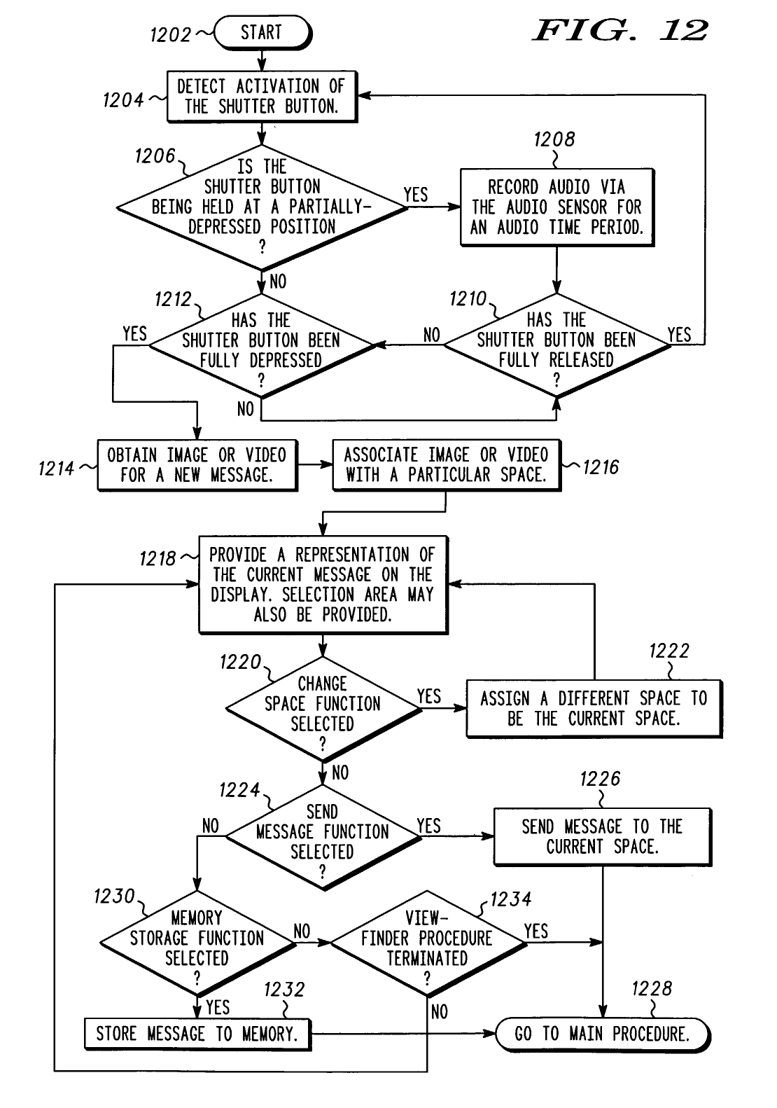

Referring to FIG. 11, there is provided a flow diagram representing a second preferred operation 1100, i.e., second preferred viewfinder procedure, of one or more communication devices 102. For this second preferred operation 1100, the communication device 102 operates in express mode to simplify communication of visual images at the expense of having fewer customizable options. Specifically, the second preferred operation 1100 is another viewfinder procedure referenced by step 712 of the main procedure 700.

Beginning at step 1102, the processor 202 detects activation of a shutter button and obtains an image or video for a new message at step 1104. The image or video is then associated with a particular space at step 1106. Next, a representation of the current message is provided on the video output 220 at step 1108. Selection areas may also be provided for each of the functions described below.

If a change space function is selected via the user interface 210 at step 1110, then the processor 202 of the communication device 102 assigns a different space to be the next current space at step 1112 and provide this new current space at step 1108. If the change space function is not selected via the user interface 210, then the processor 202 may determine whether a send message function is selected via the user interface at step 1114. If so, then the processor 202 sends a message that includes the image or video, along with any corresponding audio, to one or more remote devices at step 1116 and return to the main procedure 700 at step 1118. As described above, the communication device 202 may send the message directly to other communication devices or through the communication network 104. Otherwise, the processor 202 may determine whether a memory storage function is selected via the user interface 210 at step 1120. If so, then the processor 202 stores the message to the memory 204, particularly the database portion 214, at step 1122 and return to the main procedure 700 at step 1118. Finally, the processor 202 may determine whether the second preferred operation 1100 is to be terminated at step 1124. If the second preferred operation 1100 is to be terminated, then the processor 202 returns to the main procedure 700 at step 1118. If the second preferred operation 1100 is not to be terminated, then the second preferred operation continues to provide the representation of the current message on the video output 220 at step 1104.

Referring to FIG. 12, there is provided a flow diagram representing a third preferred operation, i.e., third preferred viewfinder procedure, of one or more communication devices. For this third preferred operation 1200, the communication device 102 provides a features for activating the audio recording function in accordance with the present invention. The third preferred operation 1200 is another viewfinder procedure referenced by step 712 of the main procedure 700.

Beginning at step 1202, the processor 202 detects activation of a shutter button at step 1204. The processor 202 then determines whether the shutter button is being held at a partially-depressed position for a threshold period of time at step 1206. If so, then the audio input 230 records audio information for an audio time period at step 1208. Next, the processor 202 determines, at step 1210, whether the shutter button has been fully released after being held at the partially-depressed position. If the shutter button has been fully released, then the processor 202 disregards the recorded audio information and waits for another activation of the shutter button at step 1204. If the shutter button has not been fully released, then the processor 202 determines whether the shutter button has been fully depressed after being held at the partially-depressed position at step 1212. If not, then the processor 202 simply loops through steps 1210 and 1212 until the shutter button has been fully released or fully depressed. If the shutter button has been fully depressed, then the third preferred operation continues at step 1214. It should be noted that, if at step 1206 the processor 202 determines that the shutter button was fully depressed without being held at a partially-depressed position, then the processor will continue to step 1214 without recording any audio information.

Image or video is obtained for a new message at step 1214, and the image or video is then associated with a particular space at step 1216. Next, a representation of the current message is provided on the video output 220 at step 1218. Selection areas may also be provided for each of the functions described below.

If a change space function is selected via the user interface 210 at step 1220, then the processor 202 of the communication device 102 assigns a different space to be the next current space at step 1222 and provide this new current space at step 1218. If the change space function is not selected via the user interface 210, then the processor 202 may determine whether a send message function is selected via the user interface at step 1224. If so, then the processor 202 sends a message that includes the image or video, along with any corresponding audio, to one or more remote devices at step 1226 and return to the main procedure 700 at step 1228. As described above, the communication device 202 may send the message directly to other communication devices or through the communication network 104. Otherwise, the processor 202 may determine whether a memory storage function is selected via the user interface 210 at step 1230. If so, then the processor 202 stores the message to the memory 204, particularly the database portion 214, at step 1232 and return to the main procedure 700 at step 1228. Finally, the processor 202 may determine whether the third preferred operation 1200 is to be terminated at step 1234. If the third preferred operation 1200 is to be terminated, then the processor 202 returns to the main procedure 700 at step 1228. If the third preferred operation 1200 is not to be terminated, then the third preferred operation continues to provide the representation of the current message on the video output 220 at step 1218.

While the preferred embodiments of the invention have been illustrated and described, it is to be understood that the invention is not so limited. For example, for the various user-selectable functions shown and described in reference to FIGS. 7 through 12, it is to be understood that these functions may be executed in any sequential and that they are not restricted to the order shown and described herein. In addition, it is to be understood that certain functions may be deleted and other functions may be added to these user-selectable functions. Numerous modifications, changes, variations, substitutions and equivalents will occur to those skilled in the art without departing from the spirit and scope of the present invention as defined by the appended claims.

What is claimed is:

1. A wireless communication device comprising:
a transceiver configured to communicate media messages with a plurality of communication devices;
a processor configured to associate media of the media messages with spaces, each space being a grouping of media associated with a particular group of communication entities; and
an output device configured to display a visual representation of at least two media associated with a particular space.

2. The wireless communication device of claim 1, wherein the transceiver communicates the media messages via at least one of a wireless communication network and wireless peer-to-peer connection.

3. The wireless communication device of claim 1, wherein the media is at least one of image data, video data and audio data.

4. The wireless communication device of claim 1, wherein all devices of the particular group of communication devices display the same visual representation.

5. The wireless communication device of claim 1, wherein each representation of the visual representations is one of an image and a video.

6. The wireless communication device of claim 1, further comprising an audio device configured to provide at least audio representation associated with at least one visual representation.

7. The wireless communication device of claim 1, further comprising a sensor configured to generate media for at least one media message, the sensor being at least one of a video input and an audio input.

8. The wireless communication device of claim 1, further comprising:
a first sensor configured to provide context data; and
a second sensor configured to generate media for at least one media message based on the context data received from the first sensor.

9. The wireless communication device of claim 1, further comprising a memory configured to store the visual representations of the at least two media associated with the particular space.

10. The wireless communication device of claim 1, wherein the particular group of communication entities includes at least one of communication devices and users.

11. A wireless communication device comprising:
an output device configured to display a plurality of sub-media associated with a particular space, wherein the particular space is a grouping of media associated with a particular group of communication entities and each sub-media is a reduced version of original media obtained by the communication entity of the particular group.

12. The wireless communication device of claim 11, further comprising a transceiver being configured to communicate at least one of either the plurality of sub-media or the original media to the other communication entities of the particular group.

13. The wireless communication device of claim 12, wherein the transceiver communicates via at least one of a wireless communication network and wireless peer-to-peer connection.

14. The wireless communication device of claim 11, wherein each sub-media represents at least one of image data, video data and audio data.

15. The wireless communication device of claim 11, further comprising a video sensor configured to generate at least one of the original media.

16. A wireless communication device comprising:
a video sensor configured to obtain visual data;
an audio sensor configured to obtain audio data; and
an activation button configured to activate the video sensor when fully depressed and to activate the audio sensor when partially depressed for a predetermined time period.

17. The wireless communication device of claim 16, wherein the audio data is unassociated with the visual data if the actuation button is fully released after the audio data is obtained.

18. The wireless communication device of claim 16, further comprising a transceiver configured to communicate the visual data and the audio data to a remote device.

19. The wireless communication device of claim 18, wherein the transceiver automatically communicates to the remote device in response establishing to the visual data and the audio data.

20. The wireless communication device of claim 18, wherein the transceiver communicates to the remote device in response activation of a send function.

21. A method for a communication device of communicating visual messages with other communication devices, the method comprising:
providing a first visual representation representing first visual data on a display of the communication device;
detecting activation of a shutter;
obtaining second visual data in response to detecting the activation; and
providing a second visual representation representing the first and second visual data on the display.

22. The method of claim 21, further comprising sending the second visual data to a remote device.

23. The method of claim 21, further comprising:
obtaining audio data before detecting the activation; and
associating the audio data with the second visual data.

24. The method of claim 21, further comprising:
obtaining audio data in response to detecting the activation; and
associating the audio data with the second visual data.

25. The method of claim 21, wherein:
the first and second visual data are based on original media; and
the first and second visual representations include a reduced version of the original media.

26. A method for a communication device of communicating visual messages with other communication devices, the method comprising:
providing a first visual representation representing first visual data on a display of the communication device;
receiving second visual data from a remote device;
providing a second visual representation representing the first and second visual data on the display.

27. The method of claim 26, further comprising sending the second visual data to a remote device.

28. The method of claim 26, further comprising:
obtaining audio data before receiving second visual data; and
associating the audio data with the second visual data.

29. The method of claim 26, further comprising:
obtaining audio data in response to receiving second visual data; and
associating the audio data with the second visual data.

30. The method of claim 26, wherein:
the first and second visual data are based on original media; and
the first and second visual representations include a reduced version of the original media.

31. A method for a communication device of communicating visual messages with other communication devices, the method comprising:
acquiring a first visual data based on a first original media;
associating the first visual data with a particular space, the particular space being a grouping of media associated with a particular group of communication entities;
providing a first visual representation representing the first visual data on a display, the first visual representation including a reduced version of the first original media;
acquiring a second visual data based on a second original media;
associating the second visual data with the particular space; and
providing a second visual representation representing the first and second visual data on the display, the second visual representation including reduced versions of the first and second original media.

32. The method of claim 31, further comprising:
acquiring a third visual data based on a third original media;
associating the third visual data with the particular space; and
providing a third visual representation representing the first, second and third visual data on the display, the third visual representation including reduced versions of the first, second and third original media.

33. The method of claim 31, wherein acquiring a first visual data based on a first original media includes receiving the first visual data from a remote device.

34. The method of claim 31, wherein acquiring a first visual data based on a first original media includes acquiring the first visual data based on at least one of an image, video and audio.

35. The method of claim 31, further comprising adding the second visual data to all previous data associated with the particular space.

36. The method of claim 35, further comprising:
detecting that a quantity of visual data for the particular space has reached a predetermined maximum threshold; and
deleting an existing visual data from all previous data associated with the particular space before adding the second visual data.

37. The method of claim 31, further comprising obtaining a thumbnail image for each original media.

38. The method of claim 31, further comprising obtaining the second original images via a video sensor.

39. A method for a communication device of communicating visual messages with other communication devices, the method comprising:
detecting a partial depression of an activation button of the communication device;
obtaining audio data via an audio sensor of the communication device in response to detecting the partial depression of the activation button;
detecting a full depression of the activation button of the communication device; and
obtaining video data via a video sensor of the communication device in response to detecting the full depression of the activation button.

40. The method of claim 39, further comprising unassociating the audio data from the visual data if the actuation button is fully released after the audio data is obtained.
